(19) United States
(12) Patent Application Publication
(10) Pub. No.: US 2013/0141394 A1
(43) Pub. Date: Jun. 6, 2013

(54) ELECTRONIC SYSTEMS AND TRACK DETECTION METHODS

(71) Applicants: Chia-Te Chou, New Taipei City (TW); Shou-Te Wei, New Taipei City (TW); Hsun-Chih Tsao, New Taipei City (TW)

(72) Inventors: Chia-Te Chou, New Taipei City (TW); Shou-Te Wei, New Taipei City (TW); Hsun-Chih Tsao, New Taipei City (TW)

(73) Assignee: WISTRON CORP., New Taipei City (TW)

(21) Appl. No.: 13/609,167

(22) Filed: Sep. 10, 2012

(30) Foreign Application Priority Data
Dec. 6, 2011 (TW) TW100144781

(51) Int. Cl. G06F 3/042

(52) U.S. Cl. 345/175

(57) ABSTRACT

An electronic system is provided, including a writing device, first and second image capturing units and a control module. The writing device has a pen point to write on a writing board, and has a first light-emitting unit to emit a first detection light. The first and second image capturing units are respectively disposed on a first corner and a second corner of the writing board to receive the first detection light in a writing mode, in order to respectively generate first and second image signals. The control module obtains the coordinates of the writing device on the writing board according to the first and second image signals, such that, when the writing device writes on the writing board, the control module determines to operate in the writing mode, and simultaneously records a writing track of the writing device.

### CROSS REFERENCE TO RELATED APPLICATIONS

This application claims priority of Taiwan Patent Application No. 100144781, filed on Dec. 6, 2011, the entirety of which is incorporated by reference herein.

### BACKGROUND OF THE INVENTION

1. Field of the Invention

The present invention relates to electronic systems, and in particular relates to electronic systems having track detection features.

2. Description of the Related Art

The current electronic whiteboards are widely used for demonstrations instead of conventional whiteboards. The market occupation rate of the electronic whiteboards has greatly increased. However, the display panel of such electronic whiteboards is quite heavy. Therefore, structurally, it is necessary to frame the display panel with a rigid frame or fix the display panel on a wall. In general, it is quite inconvenient to install the electronic whiteboard. Moreover, in a case where the electronic whiteboard is not firmly mounted or after a long period of use, the electronic whiteboard tends to loosen and fall off from the wall.

In addition, it is impossible for a user to carry the heavy electronic whiteboard with him/her. Therefore, each application site necessitates a set of electronic whiteboards which is fixedly mounted. Consequently, the cost for the equipment and installation is very high so that increased usage of the electronic whiteboards is hindered. Therefore, there is a need for an electronic device to overcome the problem described above.

Accordingly, electronic whiteboards having interactive and touch features have been developed by manufacturers. The electronic whiteboards have special structures and a special panel. In addition, the electronic whiteboards have to be connected to a computer first before the electronic whiteboard is connected to a projector through the computer. The projector uses software applications to project the frame on the electronic whiteboard which has been calibrated. When a user uses fingers or a certain pen to write symbols on the whiteboard, the symbols are sensed by optical devices or ultrasonic devices and are delivered to the projector, such that the projector simultaneously displays the symbols. Some tool patterns are shown on the sides of the electronic whiteboard and the user can touch the tool patterns to choose the writing mode or the erasing mode. However, the electronic whiteboard system needs a special electronic whiteboard and special applications. In addition, the projector and the electronic whiteboard have to be calibrated before use. Moreover, when the user virtually writes notes on the electronic whiteboard by fingers or special pens, the notes are sent to the computer by the touch sensor and recorded by the computer. Therefore, the electronic whiteboard system is complex and the cost of the electronic whiteboard system is high. In addition, the erasing operation and the writing operation of the electronic whiteboard system are not more intuitional than the traditional whiteboard, and the notes on the electronic whiteboard and the electronic files cannot be simultaneously stored by the electronic whiteboard system. Therefore, there is a need for an electronic device to overcome the problem described above.

### BRIEF SUMMARY OF THE INVENTION

In light of the previously described problems, the invention provides an embodiment of an electronic system, including a writing device, first and second image capturing units and a control module. The writing device has a pen point to write on a writing board, and has a first light-emitting unit to emit a first detection light. The first and second image capturing units are respectively disposed on a first corner and a second corner of the writing board to receive the first detection light in a writing mode, in order to respectively generate first and second image signals. The control module obtains the coordinates of the writing device on the writing board according to the first and second image signals, such that, when the writing device writes on the writing board, the control module determines to operate in the writing mode, and simultaneously records a writing track of the writing device.

The invention also provides a track detection method, suitable for an electronic system. The fool-proof method comprises the steps of: receiving detection lights of an input device by first and second image capturing units respectively disposed on first and second corners of a writing board to correspondingly generate first and second image signals; determining which one of a writing device and an erasing device is the input device moving on the writing board according to a difference of the image characteristics of the detection lights of the first and second image signals, in order to determine whether the electronic system is to operate in a writing mode or an erasing mode; determining the electronic system to operate in the writing mode when a control module determines that the writing device having a pen point is moving on the writing board; and obtaining the coordinates of the writing device and recording the writing tracks of the writing device simultaneously in the writing mode when the writing device writes on the writing board.

The invention provides an embodiment of an electronic system, including an input device, first and second image capturing units and a control module. The input device has a light-emitting unit to generate detection lights. The first and second image capturing units are respectively disposed on a first corner and a second corner of a writing board to generate first and second image signals according to the detection lights. The control module obtains the coordinates of the writing device on the writing board and a recognition signal of the writing device according to a difference of the image characteristics of the detection lights in the first and second image signals, and outputs the coordinates and the recognition signal to a storage unit, such that movement tracks of the input device are simultaneously recorded, wherein the recognition signal indicates that the input device is a writing device or an erasing device, such that, the movement tracks are writing tracks when the input device is the writing device, and the movement tracks are erasing tracks when the input device is the erasing device

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a schematic view of the electronic system of the disclosure;

FIG. 2 illustrates an embodiment of the electronic system of the disclosure;

FIG. 3 illustrates an embodiment of the writing device of the disclosure;

FIG. 4 illustrates an embodiment of the erasing device of the disclosure;

FIG. 5A illustrates an image waveform of the detection light of the writing device 131 of the disclosure;

FIG. 5B illustrates an image waveform of the detection light of the erasing device 132 of the disclosure; and

FIG. 6 illustrates a flowchart of the track detection method of the disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

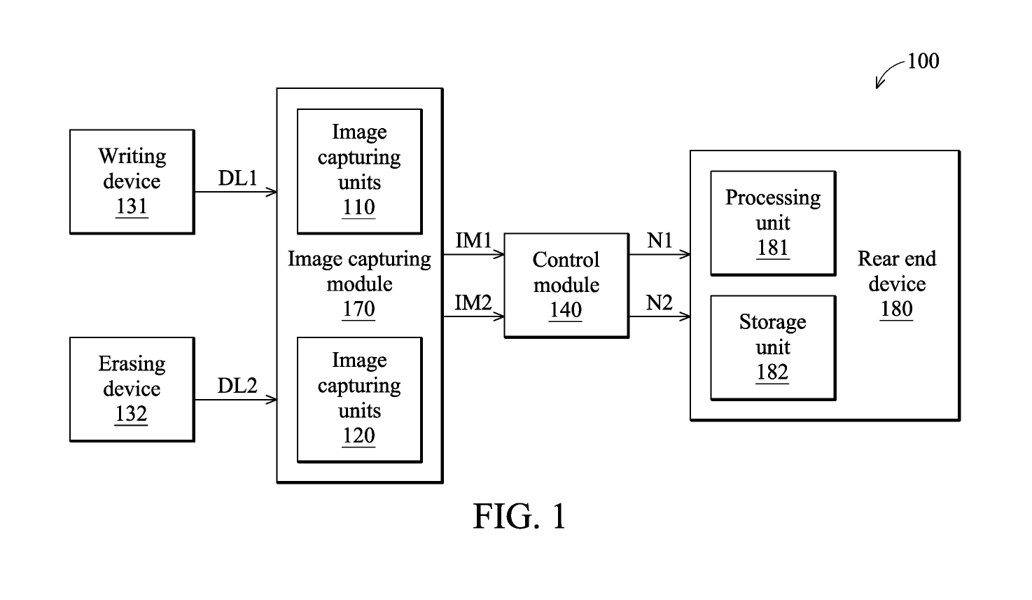

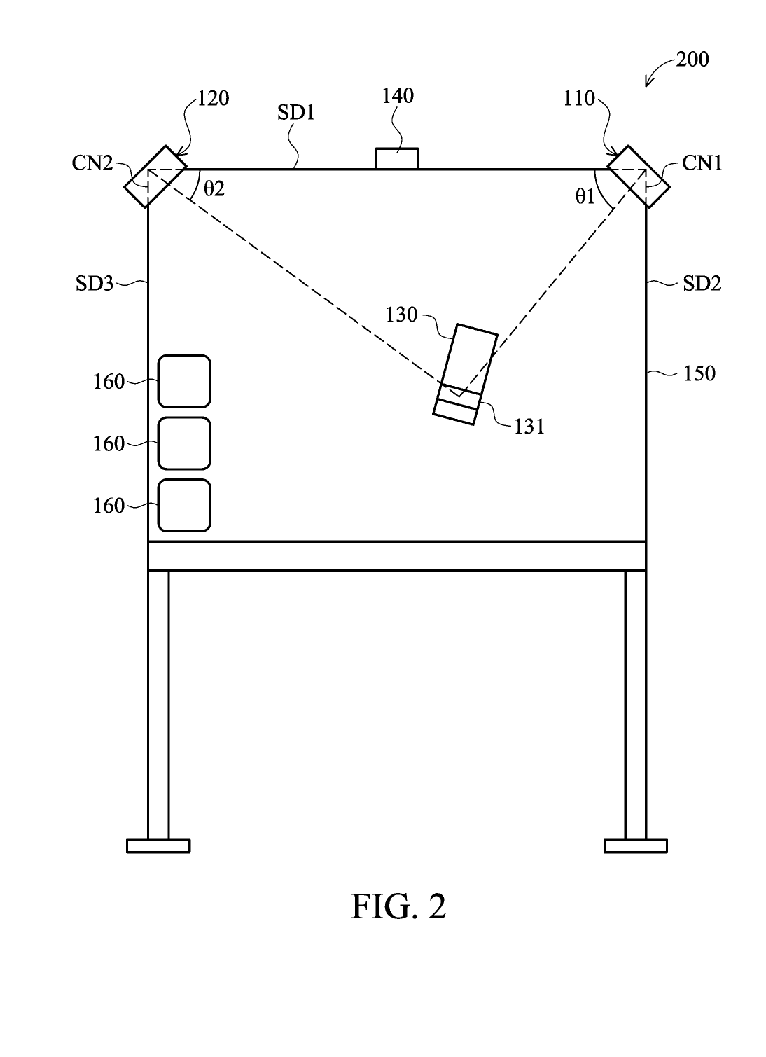

FIG. 1 illustrates a schematic view of the electronic system of the disclosure. As shown in FIG. 1, an electronic system 100 includes an image capturing module 170, a control module 140, a writing device 131, an erasing device 132 and a rear end device 180. In detail, the writing device 131 can write on a writing board (e.g., a writing board 150 shown in FIG. 2), and emit a detection light DL1 to the image capturing module 170. The erasing device 132 can erase the handwriting generated by the writing device 131 on the writing board 150, and emit a detection light DL2 to the image capturing module 170.

The image capturing module 170 has image capturing units 110 and 120 to receive the detection light DL1 in a writing mode to respectively generate image signals IM1 and IM2 or receive the detection light DL2 in an erasing mode to respectively generate the image signals IM1 and IM2. The control module 140 obtains coordinates of the writing device 131 or coordinates of the erasing device 132 on the writing board according to the image signals IM1 and IM2 respectively generated by the image capturing units 110 and 120 based on the detection light DL1 or DL2. The control module 140 determines which one of the writing device 131 and the erasing device 132 is moving on the writing board according to the difference of the image characteristics (e.g., image waveforms) of the detection lights (in the image signals IM1 and IM2), in order to determine to operate in the writing mode or the erasing mode. In the writing mode, the control module 140 simultaneously records the writing tracks of the writing device 131 when the writing device 131 writes on the writing board. In the erasing mode, the control module 140 simultaneously records the erasing tracks of the erasing device 132 when the erasing device 132 erases on the writing board.

The rear end device 180 includes a processing unit 181 and a storage unit 182, and uses a bus to connect the processing unit 181 with the storage unit 182. In some embodiments, the rear end device 180 can include recognition devices, registers, memory unit application programs and an operating system. The rear end device 180 can be handheld devices, portable devices, personal digital assistant (PDA), multiprocessor-based, microprocessor-based or programmable consumer electronics, network PCs, minicomputers, mainframe computers, and the like, but are not limited thereto.

The processing unit 181 can be disposed in a single central-processing unit (CPU) or a parallel processing unit associated with a parallel processing environment to perform a track detection process. The storage unit 182 is preferably a random access memory (RAM), but may also include read-only memory (ROM) or flash ROM. The storage unit 182 preferably stores program modules processed by the processing unit 181 to perform device and service management functions. Generally, program modules include routines, programs, objects, components, or others, that perform particular tasks or implement particular abstract data types. Some embodiments may also be practiced in distributed computing environments where tasks are performed by remote processing devices linked to a communication network. In a distributed computing environment, program modules may be located in both local and remote memory storage devices based on various remote access architectures. In the embodiment, the control module 140 can simultaneously erase the record of the writing tracks having coordinates the same as coordinates of the erasing tracks. In addition, the control module 140 can retain or cancel the record of the writing track or the erasing track of the storage unit 182 according to the user's choices.

In some embodiments, the processing unit 181 can also perform the feature which is the same as the feature of the control module 140, such as the features of “determining whether the erasing track is the same as the writing track” or “retaining or canceling the record of the writing track or the erasing track stored in the storage unit 182. For example, the control module 140 outputs a recognition signal N1 and a coordinate signal N2 to the rear end device 180 according to the image signals IM1 and IM2, such that the processing unit 181 can determine which one of the writing device 131 and the erasing 132 is moving on the writing board according to the recognition signal N1, thereby determining whether the electronic system 100 operates in a corresponding mode. When the processing unit 181 determines the writing device 131 is writing on the writing board according to the recognition signal N1, the processing unit 181 sequentially stores the coordinates of the writing device 131 in the storage unit 182 according to the coordinate signal N2 to serve as the writing tracks of the writing device 131. When the processing unit 181 determines that the erasing device 132 is erasing on the writing board according to the recognition signal N1, the processing unit 181 sequentially stores the coordinates of the erasing device 132 in the storage unit 182 according to the coordinate signal N2 to serve as the erasing tracks of the erasing device 132.

FIG. 2 illustrates an embodiment of the electronic system of the disclosure. As shown in FIG. 2, the electronic system 200 includes the image capturing units 110 and 120, input device 130 and the control module 140. In detail, the image capturing units 110 and 120 are respectively disposed on the corners CN1 and CN2 of the writing board 150. The corners CN1 and CN2 are different terminals of the side SD1 of the writing board 150. The writing board 150 can be a general whiteboard, a general blackboard, or a board having written surfaces, but is not limited thereto. The shape of the writing board 150 can be a quadrangle or any shape which the image capturing units 110 and 120 can be mounted on and not fall off from. The image capturing units 110 and 120 can be general cameras or near-infrared light capturing units, but are not limited thereto.

The input device 130 can be the writing device 131 or the erasing device 132 shown in FIG. 1. The input device 130 has a light-emitting unit 134 to emit a detection light, and the light-emitting unit 134 can be a ring-shape light-emitting unit to prevent the detection light from being obstructed by the holding part of a user's hand (e.g., finger or palm), such that the light emitted from the light-emitting unit 134 can uninterruptedly be received by the image capturing units 110 and 120 during the movement process of the input device 130. The image capturing units 110 and 120 receive the detection light and then respectively output the image signals IM1 and IM2 to the control module 140. The control module 140 calculates the angles θ1 and θ2 according to the image signals IM1 and IM2 and obtains the coordinates of the input device 130 on the writing board 150 according to the angles θ1 and θ2 and the length of the side. For example, the angle θ1 is formed with the corner CN1, the input device 130 and the side SD1. The angle θ2 is formed with the corner CN2, the input device 130 and the side SD1. The light-emitting unit 134 can be made of the near-infrared light light-emitting-diodes (LED), but is not limited thereto.

Next, the control module 140 uses the trigonometric function to calculate the distance between the input device 130 and the side SD1 as

$$\overline{SD 1} \times \frac{tan θ 1 \times tan θ 2}{tan θ 1 + tan θ 2} .$$

Similarly, the distance between the input device 130 and the side SD2 can be calculated as

$$\overline{SD 1} \times \frac{tan θ 2}{tan θ1 + tan θ2} ,$$

and the distance between the input device 130 and the side SD3 can be calculated as

$$\overline{SD 1} \times \frac{tan θ1}{tan θ1 + tan θ2} .$$

Assume that the corner CN1 is the origin (of the coordinates), the coordinate of the input device 130 is

$$( - \overline{SD 1} \times \frac{tan θ2}{tan θ1 + tan θ2} , - \overline{SD 1} \times \frac{tan θ1 \times tan θ2}{tan θ1 + tan θ2} ) .$$

The discussion above is an example for obtaining the coordinate of the input device 130, but is not limited thereto. The coordinate of the input device 130 can be calculated by another trigonometric function. In the embodiment, the control module 140 is disposed in the image capturing units 110 and 120, and the image capturing unit 110 is connected to the image capturing unit 120 through a connection cable. In some embodiments, the control module 140 uses a wireless transmission to communicate with the image capturing units 110 and 120, or the control module 140 is disposed in one of the image capturing units 110 and 120, but is not limited thereto.

In the embodiment, the electronic system 100 can use the projection unit (not shown) to simultaneously project the tracks of the input device 130 on the writing board 150. The projection unit also projects at least one functional block 160 on the part of the writing board 150, such that the user can select the track color of the input device 130 (e.g., the colors of the three blocks 160 shown in FIG. 2 can respectively be red, blue and green) when the input device 130 touches the block 160. In some embodiments, when the input device 130 touches the block 160, the projection unit can project a menu to provide additional features to the user (e.g., select the color of the writing track or the erasing track, retain or cancel the record of the writing track or the erasing track).

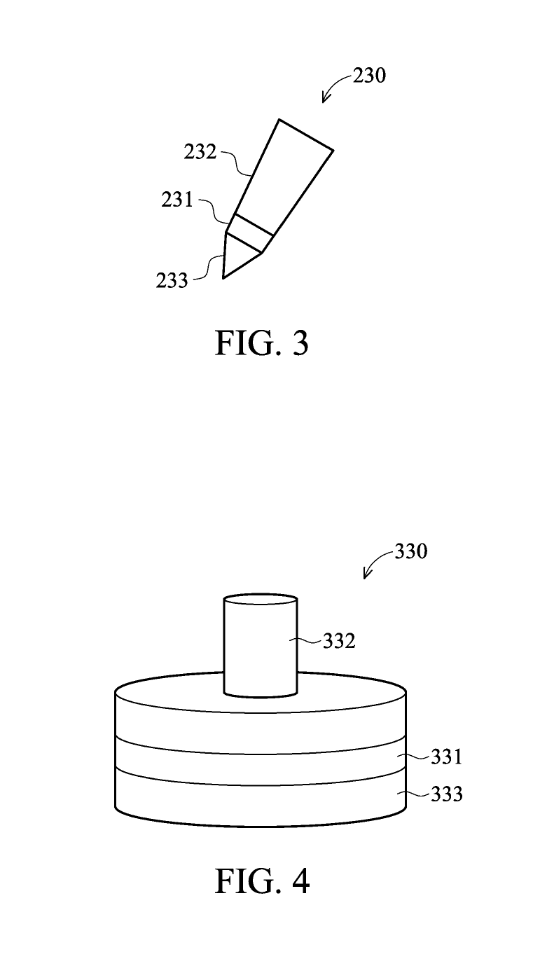

FIG. 3 illustrates an embodiment of the writing device of the disclosure. As shown in FIG. 3, the writing device 230 includes a light-emitting unit 231, a holder 232 and pen point 233. In detail, the light-emitting unit 231 is disposed between the pen point 233 and the holder 232. The user can hold the holder 232 to write on the writing board 150 and leave the real handwriting on the writing board 150. In addition, the control module 240 records the coordinates of the pen point 233 to obtain the simultaneous tracks of the writing device 230 (i.e., the simultaneous tracks of the pen point 233). In the embodiment, the track can be simultaneously and continuously recorded in a digital configuration or be recorded as an electronic file. In some embodiments, the tracks can simultaneously be projected on the writing board 150 by the rear end device 180 and the projection unit (is not shown). The combination of the holder 232 and the pen point 233 can be a white board pen, a marker, a chalk and so on, but is not limited thereto. Note that the pen point 233 can leave real traces on the writing board 150, such as ink or powder left on the writing board 150.

FIG. 4 illustrates an embodiment of the erasing device of the disclosure. As shown in FIG. 4, the erasing device 330 includes a light-emitting unit 331, a holder 332 and erasing unit 333. The erasing device 332 is similar to the writing device 231. The difference is that the erasing unit 333 can erase the real handwriting generated by the pen point 233 of the writing device 230. In the embodiment, when the movement tracks of the erasing device 330 overlap the earlier movement tracks of the writing device 230 (i.e., the coordinates are the same), the coordinates of the writing tracks are erased. In another embodiment, the projection unit can simultaneously project the tracks of the erasing unit 333, in which the track color of the erasing unit 333 is different from the pen point 233 thereof. The combination of the holder 332 and erasing unit 333 can be a general board eraser, but is not limited thereto. For example, the track color of the pen point 233 can be black, and the track color of the erasing unit 333 can be white (or a ground color of the screen). Note that the light-emitting units 134, 231, 331 can be ring-shape light-emitting units. The erasing unit 333 can erase the trace generated by the pen point 233, for example, the erasing unit 333 can erase ink or powder left on the writing board 150 by the pen point 233.

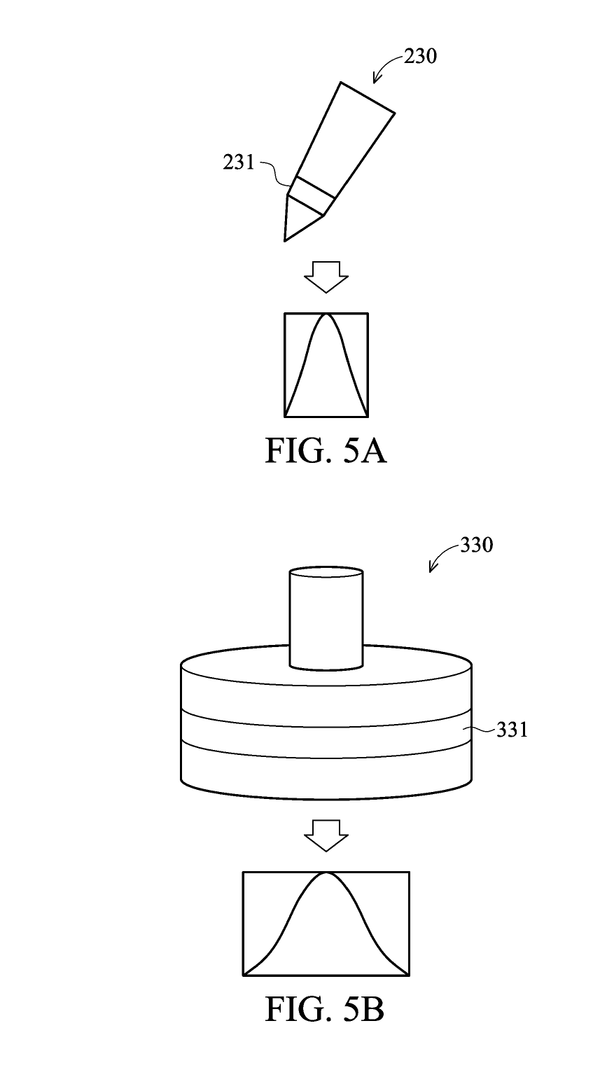

FIG. 5A illustrates an image waveform of the detection light of the writing device 131 of the disclosure. FIG. 5B illustrates an image waveform of the detection light of the erasing device 132 of the disclosure. As shown in FIG. 5A, because the width of the light-emitting unit 231 of the writing device 131 is narrower than the erasing device 132 thereof, the image waveform of the detection light received by the image capturing units 110 and 120 is narrow. As shown in FIG. 5B, because the width of the light-emitting unit 331 of the erasing device 132 is wider than the writing device 131 thereof, the image waveform of the detection light received by the image capturing units 110 and 120 is wide. The control module 140 can determine the writing device 131 or the erasing device 132 is in use according to the image waveform of the detection light of the image signals IM1 and IM2, thereby the writing tracks or the erasing tracks are correspondingly recorded.

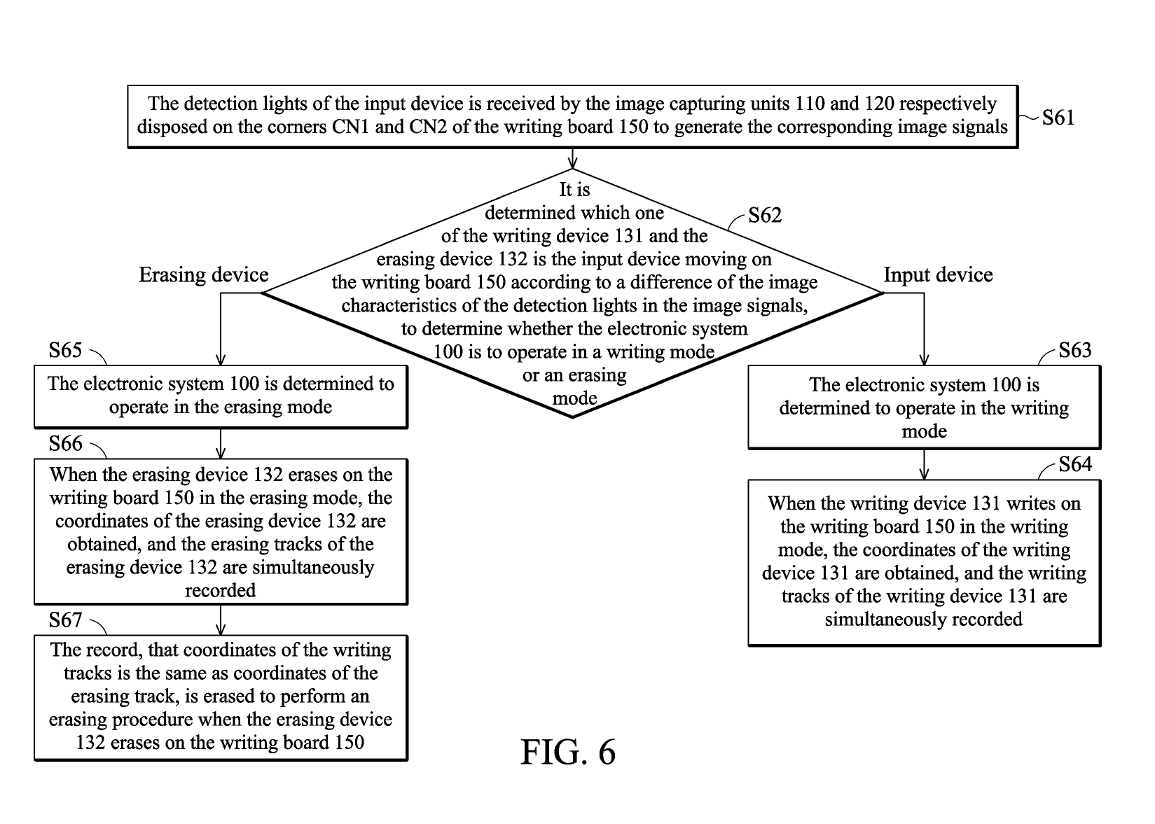

FIG. 6 illustrates a flowchart of the track detection method of the disclosure. As shown in FIG. 6, the track detection method includes the following steps.

In step S61, the detection lights of the input device is received by the image capturing units 110 and 120 respectively disposed on the corners CN1 and CN2 of the writing board 150 to generate the corresponding image signals.

In step S62, it is determined which one of the writing device 131 and the erasing device 132 is the input device moving on the writing board 150 according to a difference of the image characteristics of the detection lights in the image signals, to determine whether the electronic system 100 is to operate in a writing mode or an erasing mode. For example, the control module 140 determines that the erasing device 132 is moving on the writing board 150 when the image waveform of the detection light is wide. On the contrary, the control module 140 determines that the writing device 131 is moving on the writing board 150 when the image waveform of the detection light is narrow.

When it is determined that the writing device 131 having a pen point is moving on the writing board 150, the procedure enters step S63, and the electronic system 100 is determined to operate in the writing mode. In step S64, when the writing device 131 writes on the writing board 150 in the writing mode, the coordinates of the writing device 131 are obtained, and the writing tracks of the writing device 131 are simultaneously recorded. For example, the processing unit 181 (or the control module 140) calculates the coordinates of the writing device 131 according to the image signals IM1 and IM2 and the trigonometric function, and continuously records the coordinates of the writing device 131 to obtain the writing tracks of the writing device 131.

When it is determined that the erasing device 132 having an erasing unit 333 is moving on the writing board 150, the procedure enters step S65, and the electronic system 100 is determined to operate in the erasing mode. In step S66, when the erasing device 132 erases on the writing board 150 in the erasing mode, the coordinates of the erasing device 132 are obtained, and the erasing tracks of the erasing device 132 are simultaneously recorded. In step S67, the record, that coordinates of the writing tracks is the same as coordinates of the erasing track, is erased to perform an erasing procedure when the erasing device 132 erases on the writing board 150. For example, the processing unit 181 (or the control module 140) calculates the coordinates of the erasing device 132 according to the image signals IM1 and IM2 and the trigonometric function, and continuously records the coordinates of the erasing device 132 to obtain the erasing track of the erasing device 132. When the coordinates of the movement track are the same as the earlier coordinates of the writing track, the overlapped coordinates of the writing track are cancelled.

In summary, the electronic system 100 of the invention can be practiced in any writing board. In addition, the electronic system 100 can be practiced in a board besides the writing board, in which the image capturing units 110 and 120 can be mounted on the opposite terminals of the board, such that the electronic system 100 performs track detection and records the writing tracks or the erasing tracks at the same time. Because the electronic system 100 of the invention has no need for use of additional touch panels, the electronic system 100 is more convenient and the cost of the electronic system 100 is low.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An electronic system, comprising:
a writing device, having a pen point to write on a writing board, and having a first light-emitting unit to emit a first detection light;
first and second image capturing units, respectively disposed on a first corner and a second corner of the writing board to receive the first detection light in a writing mode, in order to respectively generate first and second image signals; and
a control module, obtaining the coordinates of the writing device on the writing board according to the first and second image signals, such that, when the writing device writes on the writing board, the control module determines to operate in the writing mode, and simultaneously records a writing track of the writing device.

2. The electronic system as claimed in claim 1, further comprising:
an erasing device, having an erasing unit to erase the handwriting generated on the writing board by the writing device, and having a second light-emitting unit to emit a second detection light, such that the control module operates in an erasing mode according to the first and second image signals, and obtains the coordinates of the erasing device on the writing board, such that, when the erasing device erases on the writing board, the control module records an erasing track of the erasing device.

3. The electronic system as claimed in claim 2, wherein the control module determines which one of the writing device and the erasing device is moving on the writing board according to a difference of the image characteristics of the first and second detection lights in the first and second image signals, thereby the writing mode or the erasing mode is determined.

4. The electronic system as claimed in claim 2, wherein, when the erasing device erases on the writing board, the control module simultaneously erases the record of the writing tracks having coordinates the same as the coordinates of the erasing tracks.

5. The electronic system as claimed in claim 3, wherein the first light-emitting unit of the writing device and the second light-emitting unit of the erasing device are ring-shaped light-emitting units.

6. The electronic system as claimed in claim 5, wherein the width of the second light-emitting unit of the erasing device is wider than the width of the first light-emitting unit of the writing device.

7. The electronic system as claimed in claim 2, further comprising:
a projection unit, projecting the writing tracks or the erasing tracks on the writing board according to the record of the writing tracks or the record of the erasing tracks.

8. The electronic system as claimed in claim 1, wherein the first detection light is a near-infrared light.

9. The electronic system as claimed in claim 1, wherein the control module is disposed in the first or second image capturing unit.

10. A track detection method, suitable for an electronic system, comprising:
receiving detection lights of an input device by first and second image capturing units respectively disposed on first and second corners of a writing board to correspondingly generate first and second image signals;
determining which one of a writing device and an erasing device is the input device moving on the writing board according to a difference of the image characteristics of the detection lights in the first and second image signals, in order to determine whether the electronic system is to operate in a writing mode or an erasing mode;
determining the electronic system to operate in the writing mode when a control module determines that the writing device having a pen point is moving on the writing board; and
obtaining the coordinates of the writing device and recording the writing tracks of the writing device simultaneously in the writing mode when the writing device writes on the writing board.

11. The track detection method as claimed in claim 10, comprising:
determining the electronic system to operate in the erasing mode when the control module determines that the erasing device having an erasing unit is moving on the writing board; and
obtaining the coordinates of the erasing device and recording the writing track of the erasing device simultaneously in the erasing mode when the erasing device erases on the writing board.

12. The track detection method as claimed in claim 11, comprising:
erasing the record that the coordinates of the writing track is the same as the erasing track thereof when the erasing device erases on the writing board.

13. The track detection method as claimed in claim 12, further comprising:
projecting the writing track or the erasing track on the writing board according to the record of the writing tracks or the record of the erasing tracks.

14. The track detection method as claimed in claim 10, wherein the detection lights are near-infrared lights.

15. The track detection method as claimed in claim 10, wherein the control module determines that the input device is the writing device or the erasing device according to a difference of the image waveforms of the detection lights in the first and second image signals.

16. An electronic system, comprising:
an input device, having a light-emitting unit to generate a detection light;
first and second image capturing units, respectively disposed on a first corner and a second corner of a writing board to generate first and second image signals according to the detection light; and
a control module, obtaining the coordinates of the writing device on the writing board and a recognition signal of the writing device according to a difference of the image characteristics of the detection lights in the first and second image signals, and outputting the coordinates and the recognition signal to a storage unit, such that movement tracks of the input device are simultaneously recorded, wherein the recognition signal indicates that the input device is a writing device or an erasing device, such that, the movement tracks are writing tracks when the input device is the writing device, and the movement tracks are erasing tracks when the input device is the erasing device.

17. The electronic system as claimed in claim 16, further comprising:
a rear end device, comprising the storage unit and a processing unit, such that the processing unit simultaneously erases record of the writing tracks having coordinates the same as coordinates of the erasing tracks when the erasing device erases on the writing board.

18. The electronic system as claimed in claim 16, wherein the light-emitting unit is a ring-shaped light-emitting unit.

19. The electronic system as claimed in claim 18, wherein the recognition signal, determining that the input device is the writing device or the erasing device, is generated according to a difference of the image waveform of the detection light resulting from difference of the sizes and the widths of the ring-shaped light-emitting units.

20. The electronic system as claimed in claim 16, further comprising:
a projection unit, projecting the writing tracks or the erasing tracks on the writing board according to the record of the writing tracks or the record of the erasing tracks.

21. The electronic system as claimed in claim 16, wherein the detection light is a near-infrared light.
